(19) United States
(12) Patent Application Publication
(10) Pub. No.: US 2014/0127829 A1
(43) Pub. Date: May 8, 2014

(54) Optical Device

(71) Applicant: Cambridge Enterprise Limited, Cambridge (GB)

(72) Inventors: Jeremy Baumberg, Cambridge (GB); Fumin Huang, Belfast (GB); Matthew Millyard, Cambridge (GB)

(73) Assignee: Cambridge Enterprise Limited, Cambridge (GB)

(21) Appl. No.: 14/117,876

(22) PCT Filed: May 16, 2012
(86) PCT No.: PCT/GB2012/051085

§ 371 Date: Jan. 6, 2014

(30) Foreign Application Priority Data
May 18, 2011 (GB) 1108344.1

(51) Int. Cl. G02F 1/01; G01N 21/00

(52) U.S. Cl. CPC G02F 1/0131; G01N 21/00; Y10S 977/834; B82Y 20/00
USPC 436/501; 250/216; 359/240; 422/69; 427/162; 977/834

(57) ABSTRACT

An optical device has a deformable solid substrate, and a two dimensional array of metal particles which is carried by the substrate. The array provides a controlled separation between nearest-neighbour particles. Deformation of the substrate produces corresponding variation in the controlled separation such that the two dimensional array undergoes a transition between metallic and insulator surface reflectance.

### FIELD OF THE INVENTION

The present invention relates to an optical device having a two dimensional array of metal particles which can undergo a transition between metallic and insulator surface reflectance.

### BACKGROUND OF THE INVENTION

Investigations into the nature of interactions between closely separated metal nanoparticles and the development of devices based on such interactions are ongoing.

A. Tao, P. Sinsermsuksakul and P. Yang, Tunable plasmonic lattices of silver nanocrystals, Nature Nanotechnology, 2, Jul. 2007, 435-440 describe a Langmuir-Blodgett technique for assembling polyhedral silver nanocrystals into macroscopic two-dimensional superlattices in which the frequency and the strength of the plasmonic response of the nanocrystal monolayers can be tuned.

WO2010/091293 proposes a device in which using silver nanocubes are interfaced with glass-supported model membranes to form a label-free sensor that measures protein binding to the membrane. The device utilizes plasmon resonance scattering of nanoparticles, which are chemically coupled to the membrane, to detect and characterize molecular interactions on the membrane surfaces.

F. Huang and J. J. Baumberg, Actively Tuned Plasmons on Elastomerically Driven Au Nanoparticle Dimers, Nano Lett. 2010, 10, 1787-1792 describe the active tuning of surface plasmons by fabricating plasmonic Au nanoparticle dimers on stretchable elastomeric films.

D. Bloor, K. Donnelly, P. J. Hands, P. Laughlin and D. Lussey, A metal-polymer composite with unusual properties, J. Phys. D: Appl. Phys. 38 (2005) 2851-2860, and D. Bloor, A. Graham, E. J. Williams, J. Laughlin and D. Lussey, Metal-polymer composite with nanostructured filler particles and amplified physical properties, Applied Physics Letters 88, 102103 (2006) describe a composite, known as QTC™, comprising nickel powders in an elastomer matrix. The retention of sharp features on the surfaces of the nickel particles and the intimate coating of the nickel particles by the matrix is believed to provide a very high resistance, even when the quantity of nickel powder incorporated in the composite is above the percolation threshold. However, the resistance of the composite is found to be highly sensitive to mechanical deformation. Experiments suggest that the principal conduction mechanism is by carriers tunnelling between the filler particles.

### SUMMARY OF THE INVENTION

The present invention is at least partly based on a realisation that a transition between metallic and insulator surface reflectance can be produced in a two dimensional array of metal particles carried by a solid substrate, and further on a recognition that a device embodying such a transition has useful applications.

Accordingly, in a first aspect, the present invention provides an optical device having:

a deformable solid substrate, and

a two dimensional array of metal particles which is carried by the substrate, the array providing a controlled separation between nearest-neighbour particles;

wherein deformation of the substrate produces corresponding variation in the controlled separation such that the two dimensional array undergoes a transition between metallic and insulator surface reflectance.

Advantageously, the transition between metallic and insulator surface reflectance can provide a very sensitive and easily identifiable indication of variation in substrate shape or volume.

A second aspect of the present invention provides a method of producing the optical device of the first aspect, the method including the steps of:

forming a self-assembling mono-layer of metal particles at an interface between a liquid and an immiscible fluid, the liquid being located on a support, and the metal particles having a coating which promotes migration of the metal particles to the interface and mono-layer assembly, and

evaporating the liquid to leave the layer of metal particles as a two dimensional array lying on the support, the coating preventing direct contact between the particles. The immiscible fluid can be a second liquid, in which case both liquids are located on the support and both are evaporated to leave the layer of metal particles as a two dimensional array lying on the support. Alternatively, the immiscible fluid can be a gas, such as air. The support can be the deformable sold substrate of the device. Alternatively, the method can include a further step of transferring the two dimensional array from the support to a surface of the deformable substrate.

A third aspect of the present invention provides use of the optical device of the first aspect as a sensor sensitive to an external stimulus which deforms the substrate, the transition between metallic and insulator surface reflectance being indicative of the presence or absence of the external stimulus. For example, the external stimulus may be selected from the group consisting of: temperature, pH, load, pressure, electromagnetic radiation, electric field, magnetic field, humidity, a chemical agent, a biochemical agent, and a biological agent.

Optional features of the invention will now be set out. These are applicable singly or in any combination with any aspect of the invention.

Preferably, the substrate is a reversibly deformable substrate, reversible deformation of the substrate producing corresponding reversible variation in the controlled separation such that the transition between metallic and insulator surface reflectance undergone by the two dimensional array is also reversible. Thus, although the two dimensional array can be carried by a “single-use” irreversibly deformable substrate, advantageously, by using a reversibly deformable substrate, the transition between metallic and insulator surface reflectance can be reversed and repeated more than once.

Conveniently, the transition between metallic and insulator surface reflectance can be produced by controlling electronic tunnelling between the particles. Thus the metallic surface reflectance is typically produced by substrate deformation states in which the controlled separation is less than that required for electronic tunnelling between the particles, and the insulator surface reflectance is typically produced by substrate deformation states in which the controlled separation is greater than that required for electronic tunnelling between the particles. Due to the electronic tunnelling, the transition can be exponentially sensitive to the separation of the nanoparticles. For example, the transition from metallic to insulator surface reflectance may occur when the controlled separation between nearest-neighbour particles exceeds a threshold separation which is less than 1 nm, or less than 0.8 or 0.5 nm.

The metallic surface reflectance may provide a reflectance of at least 30, 40 or 50% at a plasmon active wavelength of the insulator surface reflectance.

The two dimensional array of metal particles is preferably a mono-layer of metal particles.

In an undeformed state of the substrate, the two dimensional array may have a metallic surface reflectance. Then, e.g. by stretching, swelling or expanding the substrate, the transition to an insulator surface reflectance can be induced. Alternatively, however, in an undeformed state of the substrate, the two dimensional array may have an insulator surface reflectance, whereby the transition to a metallic surface reflectance can be induced e.g. by compression, shrinkage or contraction.

The metal particles can be spheres, rods, discs, cubes etc. The metal particles may have a largest dimension (i.e. diameter in the case of a sphere or length in the case of a rod) which on average is greater than about 3 nm, and preferably which is greater than about 5 or 10 nm. The metal particles may have a largest dimension which on average is less than about 300 nm and preferably which is less than about 100 or 50 nm. Such nano-sized particles can provide a strong transition between metallic and insulator surface reflectance. In particular, because such particles are smaller than the wavelength of light, the insulator surface reflectance is typically dominated by surface plasmon resonance, leading to characteristic colour evolution and intensity variation with change in the controlled separation between nearest-neighbour particles. Transition to metallic surface reflectance when the controlled separation is less than that required for electronic tunnelling between the particles can then be particularly marked.

The metal particles may be formed of copper or of a noble metal such as gold, silver or platinum, as these generally provide strong colours during insulator surface reflectance due to surface plasmon resonance. This can help to heighten the conspicuousness of the transition between metallic and insulator surface reflectance.

The substrate can conveniently be formed of an elastomeric material.

The substrate may be transparent, e.g. in order to better visualise the transition between metallic and insulator surface reflectance.

The substrate may have a thickness which is greater than about 1 μm. The substrate may have a thickness which is less than about 100 μm. Such thickness limits are compatible with use of the device e.g. as a sensor or a security feature.

The metal particles can be coated to prevent direct contact between the particles. For example, the particles can be coated with a long chain alkyl thiol such as dodecanethiol. The coating on the metal particles may have a thickness in the range from about 0.1 to 0.2 nm. Such a coating thickness can allow electronic tunnelling between the particles when the particles are in contact, but help to prevent bonding between the metal of the particles so that the controlled separation can be increased, e.g. when the substrate is stretched, swollen or expanded, to produce the transition to insulator surface reflectance.

The substrate and the two dimensional array may be configured to produce an anisotropic transition between metallic and insulator surface reflectance in the array. For example, stretching the substrate in a first direction lying in the two dimensional array may increase the controlled separation in that direction but decrease it due to Poisson contraction in a transverse second direction lying in the two dimensional array. Thus a metallic to insulator surface reflectance transition may be induced for light polarised parallel to the first direction but not for light polarised parallel to the second direction. It is possible to measure the polarisation rotation through crossed polarisers to measure this effect very sensitively. In this way, for example, the orientation of the first direction can be accurately determined.

Further optional features of the invention are set out below.

### BRIEF DESCRIPTION OF THE DRAWINGS

Embodiments of the invention will now be described by way of example with reference to the accompanying drawings in which:

FIG. 1 shows schematically steps (A) to (F) in a method for assembling nanoparticles into two dimensional mono-layer arrays and transferring the arrays onto elastomeric substrates;

FIG. 2 shows (a) an image of Au nanoparticles on a water drop sitting on a tolulene drop on a PTFE surface, and (b) a closer image of the Au nanoparticles on the water drop;

FIG. 3 shows (a) a ×125 image of a mono-layer array of the Au nanoparticles, (b) simulated reflection (R) and transmission (T) spectra from a 15 nm thick Au film, and (c) experimentally obtained reflection (R) and transmission (T) spectra for mono-layer array of 20 nm Au nanoparticles, the dashed spectrum repeating the simulated reflection from a 15 nm thick Au film; and

FIG. 4 shows (a) an image of mono-layer arrays of Au nanoparticles on a PTFE surface, and (b) an image of the of the Au arrays transferred to a PDMS substrate.

### DETAILED DESCRIPTION OF EMBODIMENTS AND FURTHER OPTIONAL FEATURES

Two dimensional arrays of noble metal or copper nanoparticles having largest dimensions of less than 300 nm generally show intense scattering-based colour due to surface plasmon resonance. The colour can be dependent on the particle size, the embedding medium and the particle shape. For spherical Au nanoparticles the colour is in the green/red spectral range. However, when such particles are packed tightly enough together such that the separation between particles is reduced to sub-nanometre scales, electronic tunnelling can occur, and the array can exhibit metallic surface reflectance, i.e. reflecting all colours as a mirror. Due to the electronic tunnelling, this transition can be exponentially sensitive to the separation of the nanoparticles.

Below is described a procedure for assembling 20 to 40 nm Au nanoparticles into two dimensional mono-layer arrays which can be assembled onto elastomeric substrates. As-assembled, the arrays have a metallic surface reflectance, the particles being close enough to allow electronic tunnelling. However, when the substrates are expanded or stretched, the separation between the particles increases, causing a transition to insulator surface reflectance. Reversal of the substrate deformation reduces the particle separation, which in turn causes a transition back to metallic surface reflectance.

The procedure can be readily adapted for assembly of two dimensional mono-layer arrays of nanoparticles having different compositions, sizes and shapes. Also, the procedure can be varied to adjust the initial separation of the nanoparticles.

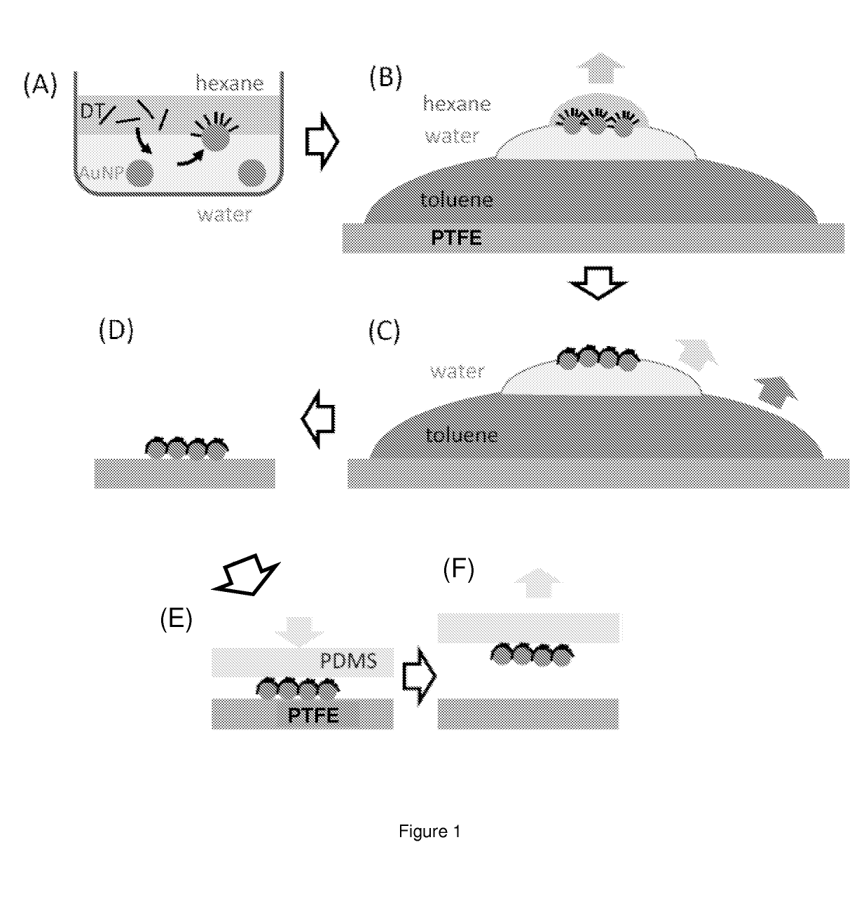

FIG. 1 shows schematically steps (A) to (F) in the procedure. At step (A), citrate-capped Au nanoparticles (AuNP) (commercially available) are stably dispersed in water stable due to charge repulsion. A hexane layer is suspended onto the water, and dodecanethiol (DT) is then added in some ethanol, allowing the DT to pass through the water/hexane interface. The DT aggressively partially coats onto the AuNP. Because the DT is strongly hydrophobic, the AuNP then moves to the interface between water and hexane, forming a two dimensional mono-layer array of nanoparticles with a citrate raft on the water side of the AuNPs and a DT raft on the hexane side of the AuNP.

At step (B), the mixture is removed in a syringe and placed onto a toluene drop which is located on a non-wetting surface, such as polytetrafluoroethylene (PTFE). The hexane evaporates most rapidly, laying down the AuNPs onto the water surface.

At step (C), the hexane has all evaporated and the DT is left in air. It lowers its surface energy by wrapping tightly around the AuNPs to form a coat of about 0.1 to 0.2 nm thickness on each particle. The surface forces also tightly push the AuNPs together so that their separation reduces to less than about 0.5 nm, allowing electronic tunnelling between the AuNPs leading to a metallic surface reflectance. However, the DT coat prevents direct contact, and hence bonding, between the metal of adjacent particles. The vapour pressure of toluene is greater than water, so it evaporates next, leaving the water tethered on the substrate where it gently evaporates laying down the AuNPs, still in a close-packed array on the PTFE surface (step (D)).

Next, at steps (E) and (F), the array of AuNPs is transferred to an elastomeric substrate, such as polydimethylsiloxane (PDMS). A flat PDMS layer is prepared and placed on top of the AuNP array and pressure applied. The adhesion of the AuNPs to the PTFE is generally weaker than to the PDMS so that, when the PDMS is peeled off, the AuNP can be transferred to the PDMS.

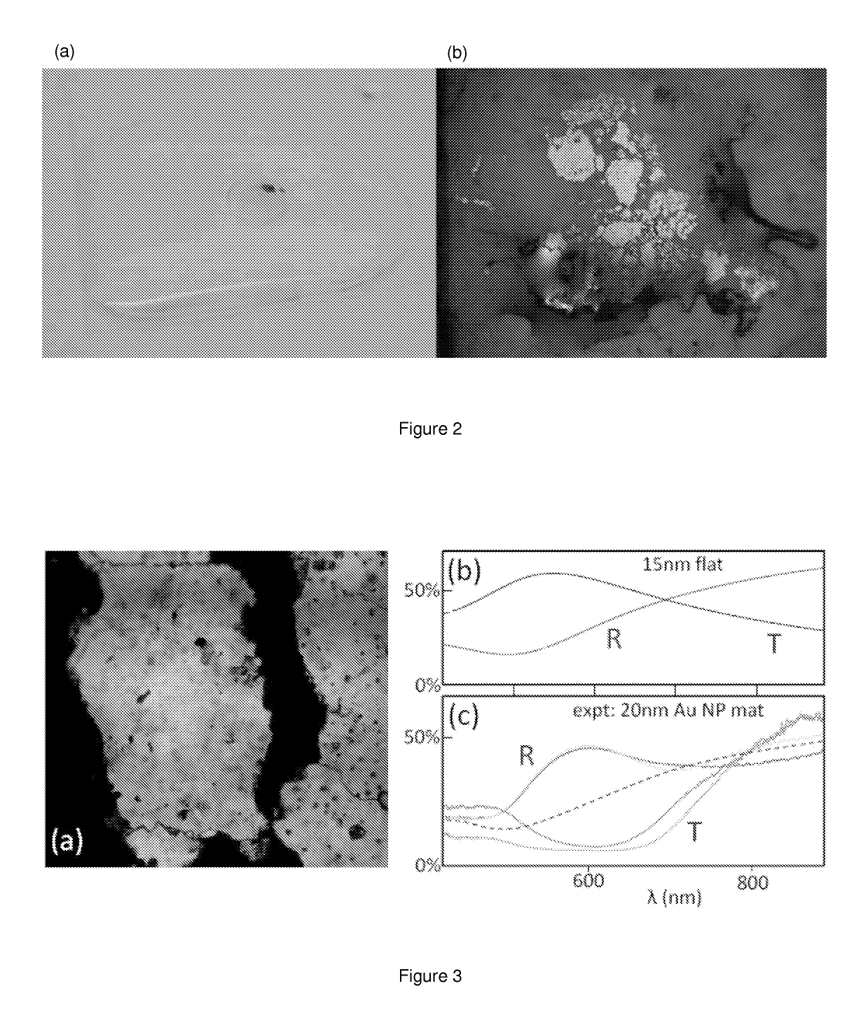

FIG. 2 shows (a) an image of the AuNPs on a water drop sitting on a drop tolulene on a PTFE surface (i.e. step (C) above), and (b) a closer image of the AuNPs on the water drop.

FIG. 3 shows (a) a ×125 image of a mono-layer array of the AuNPs, (b) simulated reflection (R) and transmission (T) spectra from a 15 nm thick Au film, and (c) experimentally obtained reflection (R) and transmission (T) spectra for mono-layer array of 20 nm AuNPs, the dashed spectrum repeating the simulated reflection from a 15 nm thick Au film. The AuNP mono-layer arrays fall apart if disrupted, indicating that the AuNPs have not sintered together. Further, experimental spectroscopic examination of the arrays (FIG. 3(c)) shows that they have a different optical behaviour compared to flat films of Au (FIG. 3(b))). In particular the reflectivity of the arrays is higher and the transmission lower around the plasmon active region of 600 nm. This also indicates that the AuNPs are not quite touching, and electronic tunnelling (either in the quantum or thermal domains) provides the connectivity between the NPs, providing the Au colour. In contrast, separated AuNPs have a characteristic red colour.

Thus, advantageously, with only a single layer of 20 nm nanoparticles, it is possible to produce a film with 50% metallic surface reflection. This is highly suitable for use in a sensor or for producing thin film colour.

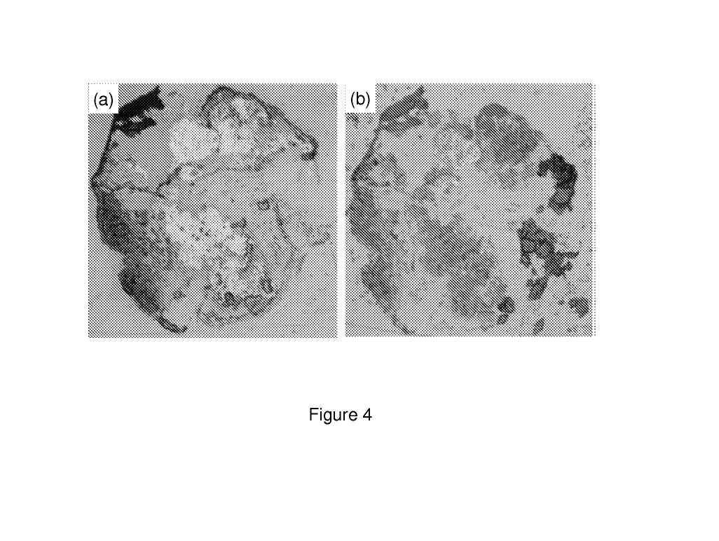

FIG. 4 shows (a) an image of the AuNPs on the PTFE surface (i.e. step (D) above), and (b) an image of the AuNPs transferred to the PDMS substrate (i.e. step (F) above).

The nearest-neighbour particle separation of the nanoparticle arrays carried by solid substrates such as PDMS are sensitive to substrate deformation (e.g. swelling, expansion, stretching etc.) upon chemical binding, temperature variation, electric fields, pressure and other external stimuli. A strong colour change as the arrays transition between metallic and insulator surface reflectance can be associated with the stimulus. Thus an optical device based on the combination of the array and substrate can be used as sensor sensitive to such stimuli. The device may also be useful as a security device in documents or items of value, such as banknotes, passports, identification cards etc., where optically variable features which cannot be reproduced by photocopier or scanner are desirable.

While the invention has been described in conjunction with the exemplary embodiments described above, many equivalent modifications and variations will be apparent to those skilled in the art when given this disclosure. Accordingly, the exemplary embodiments of the invention set forth above are considered to be illustrative and not limiting. Various changes to the described embodiments may be made without departing from the spirit and scope of the invention.

All references referred to above are hereby incorporated by reference.

1. An optical device having:
a deformable solid substrate, and
a two dimensional array of metal particles which is carried by the substrate, the array providing a controlled separation between nearest-neighbour particles;
wherein deformation of the substrate produces corresponding variation in the controlled separation such that the two dimensional array undergoes a transition between metallic and insulator surface reflectance.

2. An optical device according to claim 1, wherein the substrate is a reversibly deformable substrate, and wherein reversible deformation of the substrate produces corresponding reversible variation in the controlled separation such that the transition between metallic and insulator surface reflectance undergone by the two dimensional array is also reversible.

3. An optical device according to claim 1, wherein the metallic surface reflectance is produced by substrate deformation states in which the controlled separation is less than that required for electronic tunnelling between the particles, and the insulator surface reflectance is produced by substrate deformation states in which the controlled separation is greater than that required for electronic tunnelling between the particles.

4. An optical device according to claim 1, wherein the two dimensional array of metal particles is a mono-layer of metal particles.

5. An optical device according to claim 1, wherein, in an undeformed state of the substrate, the two dimensional array has a metallic surface reflectance.

6. An optical device according to claim 1, wherein the metal particles have a largest dimension which on average is greater than about 3 nm.

7. An optical device according to claim 1, wherein the metal particles have a largest dimension which on average is less than about 300 nm.

8. An optical device according to claim 1, wherein the metal particles are formed of copper or a noble metal such as gold, silver or platinum.

9. An optical device according to claim 1, wherein the substrate is formed of an elastomeric material.

10. An optical device according to claim 1, wherein the substrate is transparent.

11. An optical device according to claim 1, wherein the metal particles are coated to prevent direct contact between the particles.

12. A method of producing the optical device of claim 1, the method including the steps of:
forming a self-assembling mono-layer of metal particles at an interface between a liquid and an immiscible fluid, the liquid being located on a support, and the metal particles having a coating which promotes migration of the metal particles to the interface and monolayer assembly, and
evaporating the liquids to leave the layer of metal particles as a two dimensional array lying on the support, the coating preventing direct contact between the particles.

13. A method of according to claim 12, wherein the immiscible fluid is a second liquid, both liquids being located on the support and being evaporated to leave the layer of metal particles as a two dimensional array lying on the support.

14. A method of according to claim 12 including the further step of:
transferring the two dimensional array from the support to a surface of the deformable substrate.

15. Use of the optical device of claim 1 as a sensor sensitive to an external stimulus which deforms the substrate, the transition between metallic and insulator surface reflectance being indicative of the presence or absence of the external stimulus.
